(19) United States
(12) Patent Application Publication
(10) Pub. No.: US 2004/0185195 A1
(43) Pub. Date: Sep. 23, 2004

(54) Laminated glass and structural glass with integrated lighting, sensors and electronics

(76) Inventors: Christopher C. Anderson, Wilmington, DE (US); Sheila Kennedy, Boston, MA (US); Thomas C. O'Brien, Wilmington, DE (US); Marie B. O'Regan, Santa Barbara, CA (US); C. Anthony Smith, Vienna, WV (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/635,148

(22) Filed: Aug. 5, 2003

Related U.S. Application Data
(60) Provisional application No. 60/462,235, filed on Apr. 11, 2003.
(60) Provisional application No. 60/401,257, filed on Aug. 6, 2002.

(51) Int. Cl. E06B 3/24

(52) U.S. Cl. 428/34; 428/49

(57) ABSTRACT

This invention relates to laminated glass, structural glass blocks and structural plyglass as carrying cases for solid state lighting, sensors, energy generation and storage devices and other electronics that are contained within the transparent non-glass interlayers or air cavities of the laminated glass, structural glass blocks and structural plyglass.

### FIELD OF THE INVENTION

This invention relates to laminated glass comprised of at least two layers of glass separated by a transparent non-glass interlayer or an air cavity wherein solid state lighting, sensors, energy generation and storage devices and other electronics are contained within the transparent non-glass interlayer or air cavity. This invention also relates to structural glass blocks and structural plyglass wherein solid state lighting, sensors, energy generation and storage devices and other electronics are contained within the air cavity of the hollow glass block or within the non-glass interlayers of the plyglass.

### TECHNICAL BACKGROUND OF THE INVENTION

Laminated glass is commonly used in construction for such purposes as internal and external walls and windows. Such laminated glass typically consists of at least two layers of glass separated by a transparent non-glass interlayer or an air cavity. For example, a conventional laminated glass double glazed window or wall typically consists of two glass structures separated by an air cavity, wherein each glass structure consists of two layers of glass separated by a transparent non-glass interlayer. Conventional structural glass blocks are also commonly used in construction for such purposes as internal and external walls and windows. These glass blocks typically contain a large air cavity.

An objective of this invention is to use the non-glass interlayer and/or the air cavity in laminated glass and the air cavity in glass blocks to contain solid state lighting, sensors, energy generation or storage devices and other electronics to enhance the functionality and the aesthetics of the laminated glass and glass blocks.

### SUMMARY OF THE INVENTION

This invention provides a laminated glass comprised of at least two layers of transparent glass with adjacent glass layers separated by a transparent solid non-glass interlayer or an air cavity, wherein at least one transparent non-glass interlayer or air cavity contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

This invention also provides a laminated glass comprised of at least one layer of transparent glass and at least one layer of transparent polymer with adjacent glass layers, adjacent transparent polymer layers and adjacent glass and transparent polymer layers separated by a transparent non-glass interlayer or an air cavity, wherein at least one transparent non-glass interlayer or air cavity contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

This invention further provides a hollow structural glass block within which there is an air cavity, wherein said air cavity contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

This invention also provides a structural plyglass block, a laminated glass block, comprised of n layers of transparent glass and n−1 layers of transparent solid non-glass interlayers, wherein n≧2; all layers of transparent glass and all layers of transparent solid non-glass interlayers have essentially the same lateral dimensions; adjacent transparent glass layers are separated by one of said transparent solid non-glass interlayers; and at least one of the layers of transparent glass and of transparent solid non-glass interlayers is positioned to extend beyond the other layers on two adjacent sides of the structural laminated glass block. Preferably, at least two of the layers of transparent glass and of transparent solid non-glass interlayers are positioned to extend beyond the other layers on two adjacent sides of the structural plyglass block. Especially preferred is a configuration wherein the layers of transparent glass and the layers of solid non-glass interlayers are positioned with respect to one another such that all the layers of transparent glass are aligned and all the layers of transparent solid non-glass interlayers are aligned, and all the layers of aligned transparent glass extend beyond all the layers of aligned transparent solid non-glass interlayers on two adjacent sides of the structural laminated glass block and all the aligned layers of transparent solid non-glass interlayers extend beyond all the aligned layers of transparent glass on the two opposite sides of the structural laminated glass block.

This invention also provides the structural laminated glass block described above wherein at least one of the solid non-glass interlayers contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

This invention also provides a safety illumination system comprising a sensor to detect the existence of a safety problem; an illumination device comprising at least one organic light-emitting diode; and means to convey a signal from the sensor to the illumination device to impose a voltage across the at least one organic light-emitting diode of the illumination device to activate the illumination device and thereby provide the desired illumination.

### BRIEF DESCRIPTION OF THE DRAWINGS

FIG. 1 shows four of the displays obtained in Example 1 when using a glass laminate of the invention to provide a window display.

FIG. 2 shows a cross-sectional view of the laminated glass of the invention used in Example 2.

FIG. 3a shows the illumination of the laminated glass of the invention used in Example 2 when no pressure is applied to the laminated glass and FIG. 3b shows the illumination of the laminated glass when pressure is applied.

FIG. 4 shows three views of the structural laminated glass block of this invention.

### DETAILED DESCRIPTION OF THE INVENTION

One aspect of this invention relates to laminated glass comprised of glass layers separated by a transparent solid non-glass interlayer or an air gap and to the utilization of the transparent solid non-glass interlayer or the air cavity between the glass layers of the laminated glass for the integration of a broad range of functions that enhance the functionality and the aesthetics of the laminated glass. The laminated glass is comprised of at least two layers of transparent glass with adjacent glass layers separated by a transparent solid non-glass interlayer or an air cavity. One embodiment of this aspect of the invention is a laminated glass comprised of two layers of transparent glass separated by a transparent solid non-glass interlayer. Another aspect of this invention relates to laminated glass comprised of at least one glass layer and at least one transparent polymer layer separated by a transparent solid non-glass interlayer or an air gap and to the utilization of the transparent solid non-glass interlayer or the air cavity between the glass and polymer layers of the laminated glass for the integration of a broad range of functions that enhance the functionality and the aesthetics of the laminated glass. The laminated glass is comprised of at least one layer of transparent glass and at least one layer of transparent polymer with adjacent glass layers, adjacent transparent polymer layers and adjacent glass and transparent polymer layers separated by a transparent non-glass interlayer or an air cavity. One embodiment of this aspect of the invention is a laminated glass comprised of a layer of transparent glass and a layer of transparent polymer separated by a transparent non-glass interlayer or an air cavity.

These two types of laminated glass provide a “carrying case” that allows digital and thin film technologies to be integrated into or alongside the transparent solid non-glass interlayer or into the air cavity. This allows the transparent solid non-glass interlayer to serve two purposes, that of a shatter resistant material and as a host for a device that adds additional functions to the laminated glass. Similarly, it allows the air cavity to serve two purposes, that of thermal insulator and as a host for a device that adds additional functions to the laminated glass. As used herein, “transparent” when used in connection with transparent solid non-glass interlayer means a solid non-glass interlayer which transmits light with no appreciable scattering as well as a solid non-glass interlayer which is translucent, i.e., which partially transmits light. The degree of transparency required of the transparent solid non-glass interlayer will usually be dictated by how the laminate is to be used. If the use requires as completely transparent a laminate as possible, e.g., for use as a window, the transparent solid non-glass interlayer should transmit light with no appreciable scattering. If the laminate is to be used as a stair tread or stair riser, a transparent solid non-glass interlayer that partially transmits light can be quite acceptable.

The invention provides that at least one transparent solid non-glass interlayer or air cavity contain a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors. When a transparent solid non-glass interlayer is used, the interlayer may be perforated to provide space for the elements of the device. Alternatively, the elements of the device may be adjacent to the transparent solid non-glass interlayer. Preferred as the transparent solid non-glass interlayer is a Butacite® PVB (polyvinyl butyral) available from E. I. du Pont de Nemours and Company, Wilmington, Del. Also preferred as the transparent solid non-glass interlayer is an ionoplast interlayer available in the SentryGlas® Plus laminated glass construction from E. I. du Pont de Nemours and Company, Wilmington, Del. Transparent electrical conductors such as indium tin oxide can be deposited directly onto the transparent glass or the transparent polymer.

The solid state lighting can be in the form of light-emitting diodes (LEDs), an optoelectrical device consisting of a p-n junction that emits light (ultraviolet, visible or infrared radiation) in response to a forward current passing through the diode. LEDs are made using inorganic materials. The solid state lighting can also be in the form of organic light-emitting diodes (OLEDs). The OLEDS can be polymeric light-emitting diodes (PLEDs) or small molecule organic light-emitting diodes (SMOLEDs). Transparent electrical conductors can be used to provide means to apply an activating voltage to the LEDs or OLEDs. Indium tin oxide is a preferred transparent electrical conductor. The source of illumination can also be in the form of an electroluminescent (EL) film. A microprocessor chip to control the solid state lighting can be provided either as part of the device contained in at least one transparent solid non-glass interlayer or air cavity or can be provided externally to the laminated glass. The microprocessor chip can be programmed to cause the solid lighting to display a sequence of images. The images can be in the form of a pictorial or aesthetic display or text. When a thin film capacitance sensor is made part of the device, the motion of an object, such as a hand, can change the display. The laminated glass remains transparent over the parts of the laminated glass where there is no solid state lighting or where the solid state lighting is not activated. The portion of the laminated glass where the solid state lighting is activated displays images and information such as temperature, time, stock prices, etc. as well as programmable text and messages. The laminated glass can serve as a window, as an internal or external wall or surface, as an automotive windscreen, sunroof or instrumentation panel, as a kitchen appliance display, as glazing in airplanes, trains or subways, or as a display surface.

The air cavity of a conventional laminated double glazed window provides ample space for the device described above in any of its forms. A conventional laminated double glazed window is comprised of a glass-interlayer-glass member separated from a second glass-interlayer-glass layer by and air cavity. One such device converts energy received in the form of light from the sun or other light sources into electrical energy that can be stored in a battery and used to power LEDs, OLEDs, electroluminescent films, liquid crystal display films, electrochromic suspended particle device films, etc. For example, the device can be comprised of a thin film photovoltaic panel, a rechargeable thin film lithium battery and transparent indium tin oxide films to conduct electricity between the various elements. Alternatively, the battery could be used to power another device not within the window. With the addition of a microprocessor to control the illumination, the energy stored in the battery can be used to provide different types of displays in the window depending on the time of the day. For example, the display could supply information, advertising, etc. during daylight hours; it could supply illumination during the evening hours; it could act as a night light. Since the lithium battery is opaque and typical reasonably priced photovoltaic cells are opaque, these elements are localized in one portion area of the air cavity. This device comprised of a thin film photovoltaic panel and a rechargeable thin film lithium battery can also be used in other embodiments of the laminated glass.

A device that is useful in the laminated glass of this invention is one that adjusts the translucency and/or color of the laminated glass in response to the amount of exterior light impinging on the laminated glass and to thereby provide appropriate shading. The device is comprised of a light sensor to sense the impinging light, a suspended particle device film or a liquid crystal display film and means to use the output of the light sensor to adjust the translucency and/or color of the suspended particle device film or the liquid crystal display film.

The embodiment of the invention of a laminated glass comprised of two layers of transparent glass separated by a transparent solid non-glass interlayer, i.e., glass-interlayer-glass, or a laminated glass comprised of three layers of transparent glass and two transparent solid non-glass interlayers, i.e., glass-interlayer-glass-interlayer-glass, are particularly useful as illuminated stair treads, stair risers or floor tiles. The transparent solid non-glass interlayer can be illuminated by LEDs or OLEDs in the transparent solid non-glass interlayer or by LEDs or OLEDs positioned at the edges of the transparent solid non-glass interlayer. In the case of a stair tread or floor tile, a sensor detects a foot placed on the laminated glass. A microprocessor can use the presence or absence of a signal from the pressure sensor to activate and vary the lighting contained within the laminated glass. The laminated glass comprised of three layers of transparent glass and two transparent solid non-glass interlayers with each transparent solid non-glass interlayer containing a lighting device provides an even wider variety of lighting variations than the laminated glass comprised of two layers of transparent glass separated by a transparent solid non-glass interlayer. With two lighting devices within the laminated glass, detection by the pressure sensor of a foot placed on the laminated glass can be used to turn off the illumination coming from one of the transparent solid non-glass interlayers and turn on the illumination coming from the other transparent solid non-glass interlayer. Alternatively, both could be turned on. In another use, the signal from pressure sensors as a result of a foot impacting the bottom step of a staircase or the top step of a staircase could be used to increase the illumination of all the treads in the staircase by activating additional LEDs or OLEDs. Alternatively, the signal from pressure sensors as a result of a foot impacting the bottom step of a staircase or the top step of a staircase could be used to activate a laminated glass display of this invention mounted along the wall of the staircase to convey information, directions, etc.

The present invention also relates to a safety illumination system comprising a sensor to detect the existence of a safety problem, an illumination device comprising at least one OLED, and means to convey an signal from the sensor to the illumination device to impose a voltage across the anode and the cathode of the illumination device to activate the illumination device and thereby provide illumination.

The sensor may one that detects the presence of smoke, gas or motion or the absence of a usual light level in the event of an electrical power failure. The means to convey a signal from the sensor to the illumination device may be electrical or mechanical, but an electrical means is preferred. A safety illumination system may be operated by wired or wireless options. Wireless options could be used for remote control. Operation with other safety sensor systems, e.g., light, smoke, motion, or gas detectors, could be direct as in a single integrated system or wireless for a system that would consist of multiple devices. Illumination can be controlled electronically and/or manually (e.g., for dimmability), as well as sensor activated. Illumination can range from low brightness for locatability and aesthetic purposes to high brightness for safety, emergency, visibility, and information conveyance purposes.

The safety illumination system can contain more than one OLED-based illuminary, e.g., an array of OLEDs. OLEDs can also be patterned on transparent or translucent medium in a range of forms that could include panels of illumination, letters, numbers, figures/shapes, symbols or other forms alone or in combinations. It is understood that the pattern may vary as desired. For these embodiments, the anode and the OLED layer will be patterned. The layers can be applied in a pattern by, for example, positioning a patterned mask or photoresist on the first flexible composite barrier structure prior to applying the first electrical contact layer material. Alternatively, the layers can be applied as an overall layer and subsequently patterned using, for example, a photoresist and wet chemical etching. Other processes for patterning that are well known in the art can also be used. The illumination device is thin, flat, lightweight and, when deposited onto a flexible substrate, is conformable to various shapes and configurations. The illumination device will have lifetimes in excess of 1000 hours. Each illumination device consists of one or more pixels. The illumination device can emit monochromatic light, several colors or white light.

The illumination device and the sensor in a safety illumination system of this invention may be separate entities or they may be integrated into a single device.

This invention also provides a combination of safety illumination devices serving as a subsystem component as part of a larger system such as horizontal (e.g., ceiling) or vertical (e.g., walls, doors, partitions, stairway structures) surfaces. The device and/or system electronics and sensors may be embedded to enhance flexibility, reduce weight, and impart ruggedness. It provides controllable illumination and the conveyance of safety information via illumination and illuminated forms.

Thus the present invention provides a simple and cost-effective solution for making an integrated, OLED-based safety illumination system with controllable (e.g., dimming switch, electronic signals, sensor activated, remote control) light output. It is a safety illumination system that can be linked (via wires or wirelessly) to separate safety sensor devices/systems, and can be integrated within or as part of other safety sensor devices/systems.

Conventional structural glass blocks are commonly used in construction for such purposes as internal and external walls and windows. These glass blocks typically contain a large air cavity and therefore provide another type of “carrying case” that allows digital and thin film technologies to be integrated into the air cavity and thereby integrates a broad range of functions that enhance the functionality and the aesthetics of the glass blocks. Any of the devices and results discussed above in connection with the laminated glass can be used in the glass blocks. Colors of individual blocks in a glass block window or wall can be changed or the color of the whole window or wall can be changed. Glass blocks can change the amount of shading depending on the intensity of impinging light. The use of thin film capacitor sensors just below the interior surface of the glass block can provide the means to change color by waving a hand in front of the block. Remote sensors enable the glass block system to respond to environmental factors. Microprocessors and other electronic circuitry can be imbedded in the mortar between the blocks or within the blocks themselves.

This invention also provides a novel structural plyglass block, a laminated glass block. The block is comprised of n layers of transparent glass and n−1 layers of transparent solid non-glass interlayers, wherein n≧2. All layers of the transparent glass and all layers of the transparent solid non-glass interlayers have essentially the same lateral dimensions. Lateral dimensions are used herein to refer to the two dimensions in the plane of the layer, i.e., the dimensions perpendicular to the thickness of the layer. Adjacent transparent glass layers are separated by one of the transparent solid non-glass interlayers so that the exterior faces of the structural laminated glass block are always layers of transparent glass.

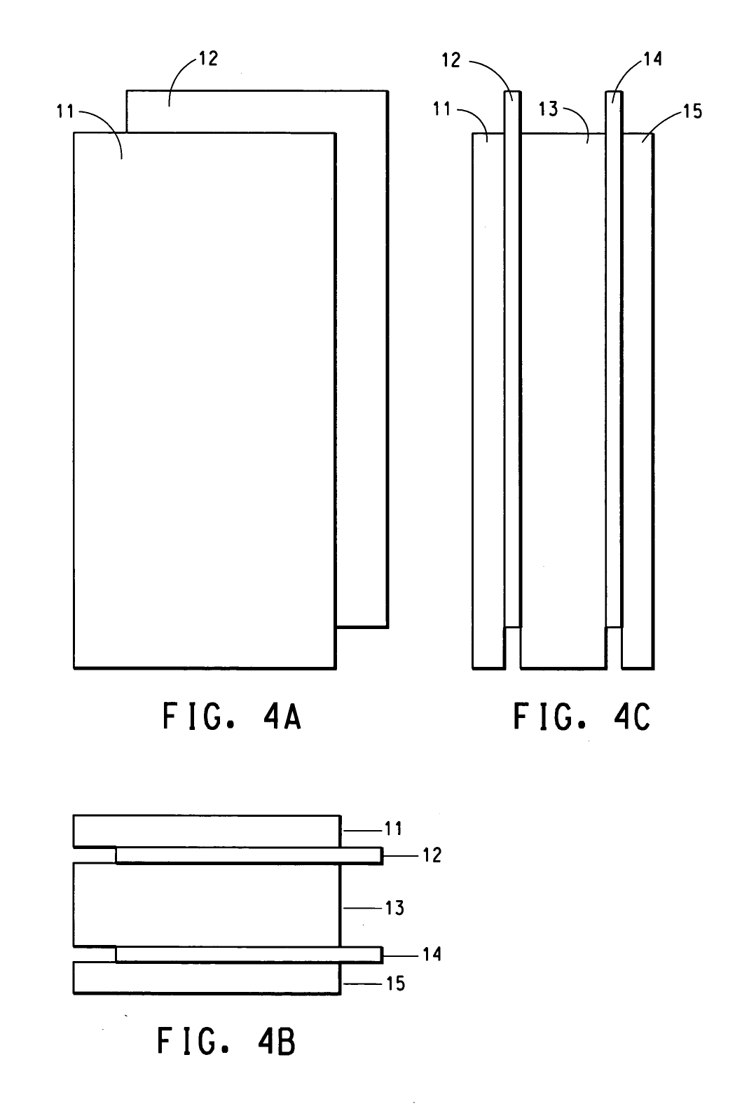

At least one of the layers of transparent glass and of transparent solid non-glass interlayers is positioned to extend beyond the other layers on two adjacent sides of the structural plyglass block. Preferably, at least two of the layers of transparent glass and of transparent solid non-glass interlayers are positioned to extend beyond the other layers on two adjacent sides of the structural laminated glass block. The purpose of the off-setting of at least one and preferably at least two of the layers with respect to the rest is to provide a means for others blocks fashioned in the same way to interfit with one another to form a sturdy window, wall, etc., comprised of these structural laminated glass blocks. Especially preferred is a configuration wherein the all the layers of transparent glass are aligned and all the layers of transparent solid non-glass interlayers are aligned. The aligned layers of transparent glass are positioned with respect to the aligned layers of transparent solid non-glass interlayers so that all the aligned layers of transparent glass extend beyond all the layers of aligned transparent solid non-glass interlayers on two adjacent sides of the structural laminated glass block and all the aligned layers of transparent solid non-glass interlayers extend beyond all the aligned layers of transparent glass on the two opposite sides of the structural laminated glass block. A transparent glass layer can consist of a single plate of glass or of several plates of glass laminated together. Similarly a transparent solid non-glass interlayer can consist of a single sheet of interlayer material or of several sheets of interlayer material laminated together. When n=3, the structural laminated glass block is a glass, non-glass interlayer, glass, non-glass interlayer, glass structure, as shown in FIG. 4. FIG. 4a shows a front view of the structural laminated glass block. Transparent glass layer 11 is the front face of the structural laminated glass block and transparent solid non-glass interlayer 12 is the, transparent solid non-glass interlayer adjacent to transparent glass layer 11. FIG. 4b shows an end cross-section of the structural laminated glass block. Transparent glass layers 11, 13 and 15 with the same lateral dimension, i.e., width, but with different thicknesses are shown aligned with one another. Transparent glass layer 15 is the back face of the structural laminated glass block. Transparent solid non-glass interlayers 12 and 14 with the same lateral dimension, i.e., width, as the transparent glass layers are shown aligned with one another, but positioned so that they extend beyond the transparent glass layers on the right side of the structural laminated glass block. Similarly, the transparent glass layers extend beyond the transparent solid non-glass interlayers on the left side of the structural laminated glass block. FIG. 4c shows a side cross-section of the structural laminated glass block. Transparent glass layers 11, 13 and 15 with the same lateral dimension, i.e., length, are shown aligned with one another. Transparent solid non-glass interlayers 12 and 14 with the same lateral dimension, i.e., length, as the transparent glass layers are shown aligned with one another, but positioned so that they extend beyond the transparent glass layers on the top side of the structural laminated glass block. Similarly, the transparent glass layers extend beyond the transparent solid non-glass interlayers on the bottom side of the structural laminated glass block. It is apparent from FIG. 4 that the two extended transparent solid non-glass interlayers would fit into the recesses of adjacent similar blocks and thereby can be joined to form an extended wall or window comprised of these structural laminated glass blocks.

The structural laminated glass block provides another type of “carrying case” that allows digital and thin film technologies to be integrated into the transparent solid non-glass interlayers and thereby integrate a broad range, of functions that enhance the functionality and the aesthetics of the structural laminated glass block. Any of the devices and results discussed above in connection with the laminated glass can be used in the structural laminated glass block. Colors of individual blocks in a structural laminated glass block window or wall can be changed or the color of the whole window or wall can be changed. Structural laminated glass blocks can change the amount of shading depending on the intensity of impinging light. The use of thin film capacitor sensors just below the interior surface of the structural laminated glass block can provide the means to change color by waving a hand in front of the block. Remote sensors enable the structural laminated glass block system to respond to environmental factors. Microprocessors and other electronic circuitry can be imbedded in the transparent solid non-glass interlayers.

### EXAMPLES OF THE INVENTION

### Example 1

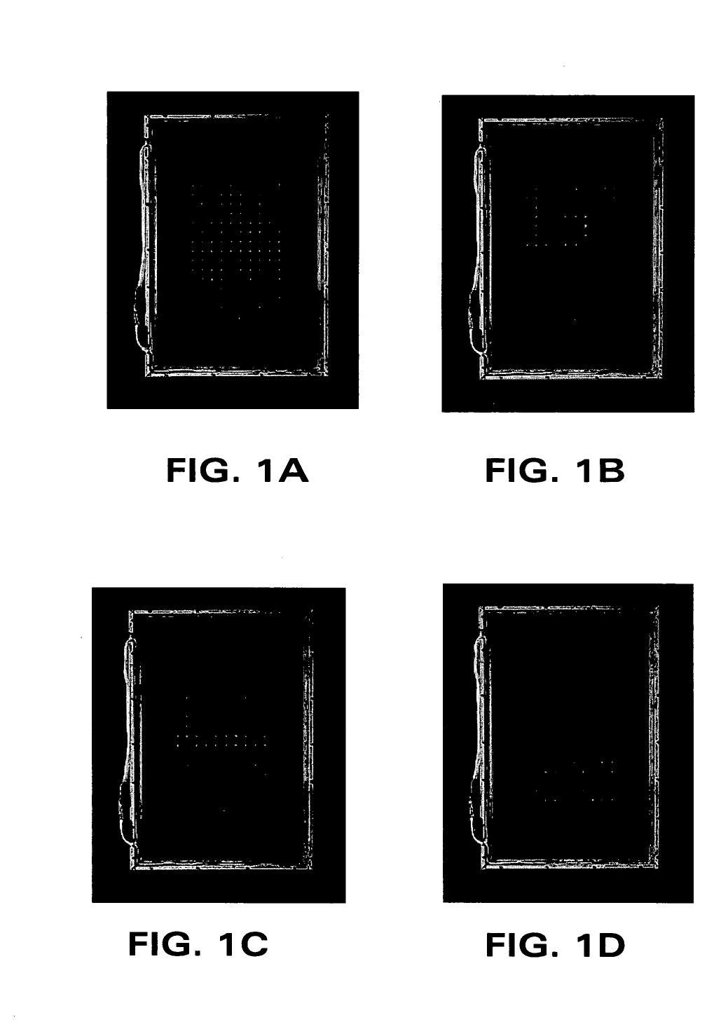

This Example demonstrates the use of laminated glass of the invention to provide a window display. The wooden frame of the window was constructed to hold two 20 inch by 30 inch (508 cm×762 cm) pieces of glass parallel and with an air gap of about 3/16 inch (0.5 cm) between them. A 10×14 array of 140 LEDs was arranged in the air gap between the two pieces of glass. This was accomplished by stringing vertically 10 very thin electrically conducting wires spaced about 1 inch (2.5 cm) apart from the top of the wooden frame to the bottom and stringing horizontally 14 very thin electrically conducting wires spaced about 1 inch (2.5 cm) apart from the top of the wooden frame to the bottom. At each intersection of the two sets of wires a commercially available blue LED was attached, the cathode to one wire and the anode to the other. The wires were positioned so that the array of LEDs was centered in the window. The LEDs were connected to a microprocessor chip, a 6 volt battery power supply and a switch to turn the display on and off, all of which were located on the wooden frame of the window. The microprocessor chip was programmed to provide various images. A few of the images are shown in FIG. 1. In FIG. 1a, all 140 LEDs are emitting. In FIG. 1b, a temperature of 19° is displayed. In FIG. 1c, a letter A is displayed. FIG. 1d is a display of a random pattern.

In a commercial window display the electrically conducting wires would be replaced by transparent indium tin oxide conductors.

### Example 2

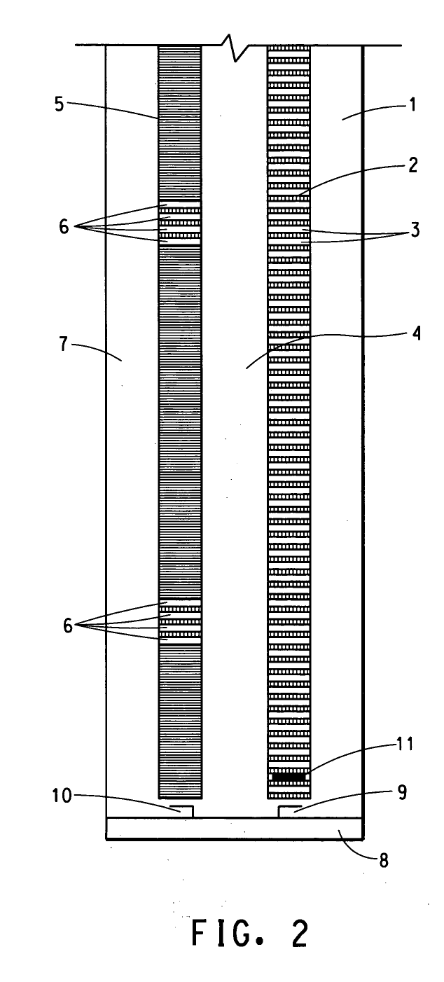

This Example demonstrates the use of laminated glass of the invention as a stair tread or floor tile. The laminated glass, 12 inches by 12 inches (30 cm×30 cm), is comprised of three layers of transparent glass and two transparent solid non-glass interlayers, all five layers having lateral dimensions of 12 inches by 12 inches (30 cm×30 cm). A cross-section of a portion of the laminated glass is shown in FIG. 2 and reference is made to FIG. 2 in the following description. A glass plate 1 that is ½ inch (1.3 cm) thick serves is the upper surface of the laminated glass. A perforated interlayer 2 is perforated DuPont SentryGlas® Plus ionoplast interlayer, obtained from E. I. du Pont de Nemours and Company, Wilmington, Del. The perforations 3 are uniformly placed throughout the interlayer 2. The next layer in the laminated glass is a glass plate 4 that is ⅜ inch (1 cm) thick. A perforated interlayer 5 is perforated DuPont SentryGlas® Plus ionoplast interlayer, obtained from E. I. du Pont de Nemours and Company, Wilmington, Del. The perforations 6 in perforated interlayer 5 are in the form of the logo of the DuPont Co. The bottom layer of the laminated glass is a glass plate 7 that is ½ inch (1.3 cm) thick. The five layers of the laminated glass are held together by an aluminum holder 8 along opposite sides of the laminated glass. The aluminum holder is comprised of two pieces of aluminum bolted together with the laminated glass between them. A row of white-emitting LEDs 9 were placed in the perforated interlayer 2 next to each of the two aluminum holders. A row of red-emitting LEDs 10 were placed in the perforated interlayer 4 next to each of the two aluminum holders. A pressure sensor 11 was placed in the perforated interlayer 2 to detect pressure applied to the upper surface of the laminated glass. A microprocessor and the related electronics were attached to the side of the laminated glass.

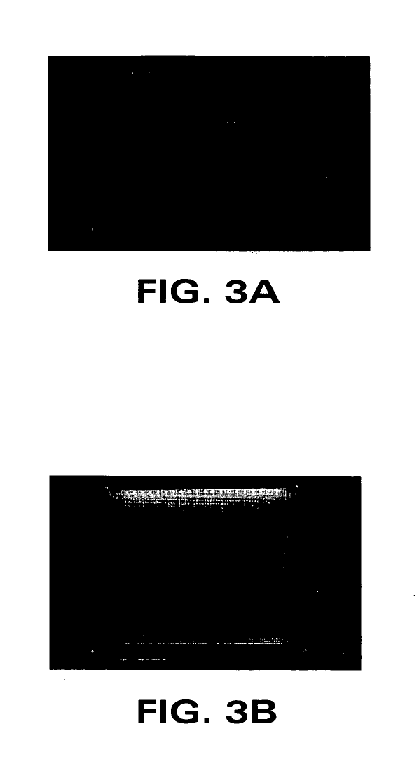

When no pressure was applied to the glass plate 1, the white-emitting LEDs 9 in the uniformly perforated interlayer 2 were activated. Light was transmitted through interlayer 2 and was scattered at the uniformly placed perforations giving a soft uniform white appearance to the laminated glass as shown in FIG. 3a. When pressured was applied to the glass plate 1, the white-emitting LEDs 9 were deactivated and the red-emitting LEDs 10 in interlayer 5 were activated. Light was transmitted through interlayer 5 and scattered at the perforations resulting in a red DuPont Co. logo as shown in FIG. 3b.

### Example 3

This Example demonstrates the use of a hollow structural glass block of the invention in a glass block window in which light in each individual block is turned on or off with the wave of a hand near the block.

The glass block window is a 3×4 array of 12 conventional glass blocks nominally 8 inch×8 inch×3.5 inch (20 cm×20 cm×8.9 cm). Each glass block was cut into two pieces. A light diffusing film was placed on the interior surface of each of the two 8 inch×8 inch (20 cm×20 cm) faces. Four green-emitting diodes were attached along each side of the piece of the block containing the front surface of the block for a total of 16 per block. A capacitor sensor to detect the presence of an object waved near the exterior surface of the block is placed inside the piece of the block containing the front surface of the block. A microprocessor is attached to the inner surface of the piece of the block containing the front surface of the block. Wires are connected from the capacitor to the microprocessor, from the microprocessor to the LEDs and to a battery supply. The two pieces of the glass block were joined together with silicone adhesive. Each of the 12 glass blocks was prepared in a similar manner and the 12 blocks were then joined in the 3×4 array of the glass window again using a silicone adhesive.

The capacitor in a given block sensed a hand waved in front of that block and the microprocessor activated the 16 LEDs in that block if they were in the “off” state and deactivated them if they were in the “on” state. Any combination of the blocks could be placed in the activated or deactivated state.

### Example 4

This Example demonstrates the production of a structural laminated glass block with n=3, i.e. a glass, interlayer, glass, interlayer, glass structural laminated glass block with the dimensions essentially as shown to scale in FIG. 4. Two glass plates 3 inches×6 inches (7.6 cm×15.2 cm) and 3/16 inch (0.5 cm) thick were used for transparent glass layers 11 and 15, the front and back faces of the structural laminated glass block. Three glass plates 3 inches×6 inches (7.6 cm×15.2 cm) and 3/16 inch (0.5 cm) thick were laminated together using epoxy and the resulting laminated glass was used for transparent glass layer 13. The transparent solid non-glass interlayers 12 and 14 were each formed by laminating together, with epoxy, two sheets of DuPont SentryGlas® Plus ionoplast interlayer, obtained from E. I. du Pont de Nemours and Company, Wilmington, Del. The five layers were laminated together using epoxy. All three glass layers were aligned and the two interlayers were aligned but the interlayers were positioned so they extended about ¼ inch (0.6 cm) beyond the glass layers at the top and the right side of the structural laminated glass block as shown in FIG. 4. A second structural laminated glass block essentially prepared as described above was prepared and used to demonstrate the fitting of the structural laminated glass blocks to one another to form a wall or window.

LEDs were inserted into the transparent solid non-glass interlayer 12 of one the structural laminated glass block and connections provided to enable the use of an external battery to activate the LEDs. Alternatively a thin film battery could be provided in the transparent solid non-glass interlayer.

### Example 5

This Example demonstrates the use of a laminated glass of the invention as a source of illumination. The laminated glass containing a PLED lighting device was fabricated in the following manner. A glass substrate was partially coated with an indium tin oxide (ITO) film to serve as the anode of the device. A poly(3,4-ethylenedioxythiophene) (PEDOT) blend, CH8000 (commercially available from Bayer AG, Germany) was spin-coated at 1,000 rpm for 80 seconds, in air, onto the ITO-coated PET. The resulting film was dried on a hot plate at 200° C. for 3 minutes and then overnight under vacuum at 60° C. A solution of a yellow emitter PDY®132 (commercially available as a pre-made solution from Covion Organic Semiconductors, GmbH, Frankfurt, Germany) was spin-coated at 330 rpm for 30 seconds, followed by 1000 rpm for 20 seconds, onto the PEDOT thin film. The PEDOT and the yellow emitter were removed in the area where the cathode and anode must make contact with the current source. A low work function metal, Ca, was vapor deposited on the film of PEDOT and the yellow emitter to a thickness of 10 to 30 nm. A layer of aluminum was vapor deposited on top of the Ca layer to a thickness of 300 nm to complete the cathode formation. A layer of uv-curable epoxy was spread over the device, but leaving the electrode contact area uncovered. A piece of glass was placed on top of the epoxy, and the epoxy was cured with uv light. When a battery was connected to the electrodes, the entire device emitted yellow light.

### Example 6

A laminated glass containing an electrolumnescent panel as a light source was prepared in the following manner. Two pieces of annealed glass, each 90 mm×85 mm, were washed with a solution of trisodium phosphate (5 gms./liter) in deionized water and then rinsed thoroughly with deionized water and dried. A sheet (0.76 mm thick) of ionomer resin composed of 81% ethylene, 19% methacrylic acid, 37% neutralized with sodium ion and having a melt index of 2 was placed on one of the pieces of glass. The moisture level of said ionomer sheet was below 0.06% by weight. The ionomer sheet had a surface roughness via an embossing technique to allow for ease of air removal from between each assembled interface. An electroluminescent (EL) panel, 70 mm×45 mm, was centered on the ionomer sheet. The sizing of the glass and ionomer sheets used herein were matched and were oversized relative to the electroluminescent panel to allow a full encapsulation of the EL panel during the subsequent lamination process. A second ionomer sheet was placed over the EL panel and the second piece of glass was positioned on top to complete the preassembly structure. The preassembly structure was then taped together with a piece of polyester tape to maintain relative positioning of each layer. A nylon fabric strip was placed around the periphery of the preassembly structure to facilitate air removal from within the layers. The preassembly structure was placed inside a nylon vacuum bag with a connection to a vacuum pump. A vacuum was applied to allow substantial removal of air from within (air pressure inside the bag was reduced to below 50 millibar absolute). The bagged preassembly structure was then heated in a convection air oven to 110° C. and held for 30 minutes. A cooling fan was then used to cool the laminated structure down to near room temperature and the laminated structure was disconnected from the vacuum source and the bag removed yielding a fully prepressed laminate of glass and interlayer. The laminated structure, although now hermetically sealed around the periphery, still had a few areas internally that had not fully bonded. The laminated structure was then placed into an air autoclave and the pressure and temperature were increased from ambient to 135° C. and 200 psi in a period of 15 minutes. This temperature and pressure was held for 30 minutes and then the temperature was decreased to 40° C. within a 20 minute period whereby the pressure was then dropped to ambient and the laminated glass structure was removed.

Application of the proper electrical current to the device indicated that the electroluminescent panel provided light and functioned as it had before encapsulation within the glass. It was now protected from physical damage and attack from moisture, air, etc. and could serve in the uses discussed herein.

### Example 7

An example of a nightlight safety illumination system of the invention is a monochrome, plug-in-the-wall OLED-based illumination device and integrated sensor electronics for wireless connection from the sensor, a stand-alone, battery operated smoke detector/alarm, to the illumination device. On activation of the smoke detector, the safety illumination device switches from low to high illumination, or flashes.

### Example 8

An example of a smoke detection safety illumination system of the invention is a monochrome, OLED-based, stand-alone, battery operated illumination device providing a safety sign and integrated sensor electronics for wireless connection from the sensor, a stand-alone, battery operated smoke detector-alarm, to the illumination device. With the activation of the smoke detector, the illumination device with the safety sign switches from low to high illumination, or flashes. The illumination device and the smoke detector may be separate devices or may be integrated into a single device.

### Example 9

An example of a smoke detection safety illumination system of the invention is a monochrome, OLED-based illumination device integrated into the surface structure of the sensor, a wired or battery operated smoke detector-alarm. With the activation of the smoke detector, the illumination device switches from off to high brightness, or flashes.

### Example 10

An example of a smoke detection safety illumination system of the invention is a OLED-based illumination device integrated into a transparent (e.g., SentryGlas Plus®, safety glass laminate available from Dupont co., Wilmington, Del.) balustrade railing or stair material for stairways and integrated sensor electronics for wireless connection from the sensor, a stand-alone, battery operated smoke detector-alarm, to the illumination device. With the activation of the smoke detector, the illumination device switches from low to high illumination. The smoke detector may be a separate device or may be integrated into the transparent balustrade railing or stair material.

### Example 11

An example of a motion detection safety illumination system of the invention is a OLED-based illumination device integrated into a transparent (e.g., SentryGlas Plus®, safety glass laminate available from Dupont co., Wilmington, Del.)) balustrade railing or stair material for stairways and integrated sensor electronics for wireless connection from the sensor, a stand-alone, battery operated motion, to the illumination device. With the activation of the motion detector, the illumination device switches from low to high illumination. The motion detector may be a separate device or may be integrated into the transparent balustrade railing or stair material.

### Example 12

An example of a power outage detection safety illumination system of the invention is a OLED-based illumination device integrated into a transparent (e.g., SentryGlas Plus®, safety glass laminate available from Dupont co., Wilmington, Del.)) balustrade railing or stair material for use in stairways or halls and with integrated sensor electronics for wireless connection from the sensor, a stand-alone, battery operated light-sensing device, to the illumination device. With the activation of the light-sensing device, the illumination device switches from off to high illumination. The light-sensing device may be a separate device or may be integrated into the transparent balustrade railing or stair material.

What is claimed is:

1. A laminated glass comprised of at least two layers of transparent glass with adjacent glass layers separated by a transparent solid non-glass interlayer or an air cavity, wherein at least one said transparent non-glass interlayer or said air cavity contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

2. The laminated glass of claim 1, wherein said device is comprised of solid state lighting.

3. The laminated glass of claim 2, wherein said solid state lighting is in the form of at least one light emitting diode.

4. The laminated glass of claim 2, wherein said solid state lighting is in the form of at least one organic light emitting diode.

5. The laminated glass of claim 2, wherein said solid state lighting is in the form of an electroluminescent film.

6. The laminated glass of any of claims 2-5, wherein said device is further comprised of transparent electrical conductors to provide means to apply an activating voltage to said solid state lighting.

7. The laminated glass of claim 6, wherein said transparent electrical conductors are indium tin oxide films.

8. The laminated glass of claim 6, wherein said device is further comprised of a microprocessor chip that is programmed to control said solid state lighting and to cause said solid state lighting to display a sequence of images.

9. The laminated glass of claim 8, wherein said microprocessor chip is programmed to cause said solid state lighting to display text.

10. The laminated glass of claim 6, wherein there is provided externally to said laminated glass a microprocessor chip that is programmed to control said solid state lighting and to cause said solid state lighting to display a sequence of images.

11. The laminated glass of claim 10, wherein said microprocessor chip is programmed to cause said solid state lighting to display text.

12. The laminated glass of claim 1 that is used as an exterior window or wall, wherein said device is comprised of a light sensor, a liquid crystal display film and means to control the translucency of said liquid crystal display film whereby as the intensity of the external light impinging on said sensor increases said means reduces said translucency of said liquid crystal display film and as the intensity of said external light impinging on said sensor decreases said means increases said translucency of said liquid crystal display film to provide variable shading of the interior.

13. The laminated glass of claim 1 that is used as an exterior window or wall, wherein said device is comprised of a light sensor, a suspended particle device film and means to control the translucency of said suspended particle device film whereby as the intensity of the external light impinging on said sensor increases said means reduces said translucency of said suspended particle device film and as the intensity of said external light impinging on said sensor decreases said means increases said translucency of said suspended particle device film to provide variable shading of the interior.

14. The laminated glass of claim 1 in the form of a conventional laminated glass double glazed window, wherein said device is contained within said air cavity of said conventional laminated glass double glazed window and said device comprises:
a) a photovoltaic cell to convert the solar energy impinging on said photovoltaic cell to electrical energy; and
b) a thin film battery to store said electrical energy.

15. The laminated glass of claim 14, wherein said thin film battery is a lithium thin film battery.

16. The laminated glass of claims 14 or 15, wherein said photovoltaic cell and said thin film battery are organized into a localized area of said laminated glass.

17. The laminated glass of claim 16, wherein said device further comprises solid state lighting that is powered by said thin film battery.

18. The laminated glass of claim 17, wherein said solid state lighting is in the form of at least one light emitting diode.

19. The laminated glass of claim 17, wherein said solid state lighting is in the form of at least one organic light emitting diode.

20. The laminated glass of claim 17, wherein said solid state lighting is in the form of an electroluminescent film.

21. A laminated glass comprised of at least one layer of transparent glass and at least one layer of transparent polymer with adjacent glass layers, adjacent transparent polymer layers and adjacent glass and transparent polymer layers separated by a transparent non-glass interlayer or an air cavity, wherein at least one said transparent non-glass interlayer or said air cavity contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

22. The laminated glass of claim 21, wherein said device is comprised of solid state lighting.

23. The laminated glass of claim 22, wherein said solid state lighting is in the form of at least one light emitting diode.

24. The laminated glass of claim 22, wherein said solid state lighting is in the form of at least one organic light emitting diode.

25. The laminated glass of claim 22, wherein said solid state lighting is in the form of an electroluminescent film.

26. The laminated glass of any of claims 22-25, wherein said device is further comprised of transparent electrical conductors to provide means to apply an activating voltage to said solid state lighting.

27. The laminated glass of claim 26, wherein said transparent electrical conductors are indium tin oxide films.

28. The laminated glass of claim 22, wherein said device is further comprised of a microprocessor chip that is programmed to control said solid state lighting and to cause said solid state lighting to display a sequence of images.

29. The laminated glass of claim 28, wherein said microprocessor chip is programmed to cause said solid state lighting to display text.

30. The laminated glass of claim 22, wherein there is provided externally to said laminated glass a microprocessor chip that is programmed to control said solid state lighting and to cause said solid state lighting to display a sequence of images.

31. The laminated glass of claim 30, wherein said microprocessor chip is programmed to cause said solid state lighting to display text.

32. The laminated glass of claim 21 that is used as an exterior window or wall, wherein said device is comprised of a light sensor, a liquid crystal display film and means to control the translucency of said liquid crystal display film whereby as the intensity of the external light impinging on said sensor increases said means reduces said translucency of said liquid crystal display film and as the intensity of said external light impinging on said sensor decreases said means increases said translucency of said liquid crystal display film to provide variable shading of the interior.

33. The laminated glass of claim 21 that is used as an exterior window or wall, wherein said device is comprised of a light sensor, a suspended particle device film and means to control the translucency of said suspended particle device film whereby as the intensity of the external light impinging on said sensor increases said means reduces said translucency of said suspended particle device film and as the intensity of said external light impinging on said sensor decreases said means increases said translucency of said suspended particle device film to provide variable shading of the interior.

34. The laminated glass of claim 21, comprised of one layer of transparent glass and one layer of transparent polymer separated by a transparent solid non-glass interlayer.

35. The laminated glass of claim 1, comprised of two layers of transparent glass separated by a transparent solid non-glass interlayer.

36. The laminated glass of claim 1, comprised of three layers of transparent glass and two transparent solid non-glass interlayers with adjacent transparent glass layers separated by one of said transparent solid non-glass interlayers, wherein both said transparent non-glass interlayers contains a said device.

37. The laminated glass of any of claims 34-36, wherein said device is comprised of solid state lighting.

38. The laminated glass of claim 37, wherein said solid state lighting is in the form of at least one light emitting diode.

39. The laminated glass of claim 37, wherein said solid state lighting is in the form of at least one organic light emitting diode.

40. The laminated glass of claim 37, wherein said solid state lighting is in the form of an electroluminescent film.

41. The laminated glass of claim 37, wherein said device is further comprised of transparent electrical conductors to provide means to apply an activating voltage to said solid state lighting.

42. The laminated glass of claim 41, wherein said transparent electrical conductors are indium tin oxide films.

43. The laminated glass of claim 41, wherein said device is further comprised of a microprocessor chip that is programmed to control said solid state lighting and to cause said solid state lighting to display a sequence of images.

44. The laminated glass of claim 43, wherein said microprocessor chip is programmed to cause said solid state lighting to display text.

45. The laminated glass of claim 41, wherein there is provided externally to said laminated glass a microprocessor chip that is programmed to control said solid state lighting and to cause said solid state lighting to display a sequence of images.

46. The laminated glass of claim 44, wherein said microprocessor chip is programmed to cause said solid state lighting to display text.

47. A luminous stair tread or floor tile comprised of the laminated glass of any of claims 2-5.

48. A luminous stair tread or floor tile of claim 47, wherein said device further comprises a pressure sensor to detect the pressure of a foot impacting said tread and to vary the illumination produced by said device depending on presence or absence of said pressure.

49. A luminous stair riser comprised of the laminated glass of any of claims 2-5.

50. A luminous stair guard rail comprised of the laminated glass of any of claims 2-5.

51. A luminous floor comprised of tiles of the laminated glass of any of claims 2-5.

52. An interior partition in a building comprised of the laminated glass of any of claims 2-5.

53. A safety sign comprised of the laminated glass of any of claims 2-5.

54. A luminous stair tread or floor tile comprised of the laminated glass of claim 37.

55. A luminous stair tread or floor tile of claim 54, wherein said device further comprises a pressure sensor to detect the pressure of a foot impacting said tread and to vary the illumination produced by said device in response to the presence or absence of said pressure.

56. A luminous stair riser comprised of the laminated glass of claim 37.

57. A luminous stair guard rail comprised of the laminated glass of claim 37.

58. A luminous floor comprised of tiles of the laminated glass of claim 37.

59. An interior partition in a building comprised of the laminated glass of claim 37.

60. A safety sign comprised of the laminated glass of claim 37.

61. A hollow structural glass block within which there is an air cavity, wherein said air cavity contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

62. The hollow structural glass block of claim 61, wherein said device is comprised of solid state lighting.

63. The hollow structural glass block of claim 62, wherein said solid state lighting is in the form of at least one light emitting diode.

64. The hollow structural glass block of claim 62, wherein said solid state lighting is in the form of at least one organic light emitting diode.

65. The hollow structural glass block of claim 62, wherein said solid state lighting is in the form of an electroluminescent film.

66. The hollow structural glass block of any of claims 62-65, wherein said device is further comprised of transparent electrical conductors to provide means to apply an activating voltage to said solid state lighting.

67. The hollow structural glass block of claim 66, wherein said transparent electrical conductors are indium tin oxide films.

68. The hollow structural glass block of claim 66, wherein said device is further comprised of a microprocessor chip that is programmed to control said solid state lighting and to cause said solid state lighting to display a sequence of images.

69. The hollow structural glass block of claim 68, wherein said microprocessor chip is programmed to cause said solid state lighting to display text.

70. The hollow structural glass block of claim 66, wherein there is provided externally to said laminated glass a microprocessor chip that is programmed to control said solid state lighting and to cause said solid state lighting to display a sequence of images.

71. The hollow structural glass block of claim 70, wherein said microprocessor chip is programmed to cause said solid state lighting to display text.

72. The hollow structural glass block of claim 66, wherein said device is further comprised of a transparent thin film capacitance sensor to detect the motion of an object across the exterior surface of said hollow structural glass block and to vary the illumination produced by said device in response to said motion.

73. A structural laminated glass block comprised of n layers of transparent glass and n−1 layers of transparent solid non-glass interlayers, wherein n≧2; all said layers of transparent glass and all said layers of transparent solid non-glass interlayers have essentially the same lateral dimensions; adjacent said transparent glass layers are separated by one of said transparent solid non-glass interlayers; and at least one of said layers of transparent glass and transparent solid non-glass interlayers is positioned to extend beyond the other said layers on two adjacent sides of said structural laminated glass block.

74. The structural laminated glass block of claim 73, wherein at least two of said layers of transparent glass and transparent solid non-glass interlayers are positioned to extend beyond the other said layers on two adjacent sides of said structural laminated glass block.

75. The structural laminated glass block of claim 74, wherein said layers of transparent glass and said layers of transparent solid non-glass interlayers are positioned with respect to one another such that all said layers of transparent glass are aligned and all said layers of transparent solid non-glass interlayers are aligned, and all said layers of aligned transparent glass extend beyond all said layers of aligned transparent solid non-glass interlayers on two adjacent sides of said structural laminated glass block and all said aligned layers of solid non-glass interlayers extend beyond all said aligned layers of glass on the two opposite sides of said structural laminated glass block.

76. The structural laminated glass block of claim 75, wherein said solid non-glass interlayers are comprised of SentryGlas® Plus ionoplast interlayer.

77. The structural laminated glass block of claim 75, wherein said solid non-glass interlayers are comprised of polyvinyl butyral.

78. The structural laminated glass block of claim 74, wherein at least one of said layers of glass is comprised of layers of glass bonded by thin transparent non-glass layers.

79. The structural laminated glass block of any of claims 73-78, wherein n=3.

80. A glass wall or window comprised of the structural laminated glass block of any of claims 73-78.

81. A glass wall or window comprised of the structural laminated glass block of claim 79.

82. The structural laminated glass block of any of claims 73-78, wherein at least one of said solid non-glass interlayers contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

83. The structural laminated glass block of claim 82, wherein said device is comprised of solid state lighting.

84. The structural laminated glass block of claim 83, wherein said solid state lighting is in the form of at least one light emitting diode.

85. The structural laminated glass block of claim 83, wherein said solid state lighting is in the form of at least one organic light emitting diode.

86. The structural laminated glass block of claim 83, wherein said solid state lighting is in the form of an electroluminescent film.

87. The structural laminated glass block of claim 83, wherein said device is further comprised of transparent electrical conductors to provide means to apply an activating voltage to said solid state lighting.

88. The structural laminated glass block of claim 87, wherein said transparent electrical conductors are indium tin oxide films.

89. The structural laminated glass block of claim 87, wherein said device is further comprised of a microprocessor chip that is programmed to control said solid state lighting and to cause said solid state lighting to display a sequence of images.

90. The structural laminated glass block of claim 87, wherein there is provided externally to said laminated glass a microprocessor chip that is programmed to control said solid state lighting and to cause said solid state lighting to display a sequence of images.

91. The structural laminated glass block of claim 79, wherein at least one of said solid non-glass interlayers contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

92. The structural laminated glass block of claim 91, wherein both of said solid non-glass interlayers contains a device comprised of at least one element selected from the group consisting of solid state lighting, heat sensors, light sensors, pressure sensors, thin film capacitance sensors, photovoltaic cells, thin film batteries, liquid crystal display films, suspended particle device films, and transparent electrical conductors.

93. The structural laminated glass of claim 91, wherein said device is comprised of solid state lighting.

94. The structural laminated glass of claim 93, wherein said solid state lighting is in the form of at least one light emitting diode.

95. The structural laminated glass of claim 93, wherein said solid state lighting is in the form of at least one organic light emitting diode.

96. The structural laminated glass of claim 93, wherein said solid state lighting is in the form of an electroluminescent film.

97. The structural laminated glass of claim 93, wherein said device is further comprised of transparent electrical conductors to provide means to apply an activating voltage to said solid state lighting.

98. The structural laminated glass of claim 97, wherein said transparent electrical conductors are indium tin oxide films.

99. The structural laminated glass of claim 97, wherein said device is further comprised of a microprocessor chip that is programmed to control said solid state lighting and to cause said solid state lighting to display a sequence of images.

100. The structural laminated glass of claim 97, wherein there is provided externally to said laminated glass a microprocessor chip that is programmed to control said solid state lighting and to cause said solid state lighting to display a sequence of images.

101. A glass wall or window comprised of the structural laminated glass block of claim 82.

102. A glass wall or window comprised of the structural laminated glass block of claim 83.

103. The glass wall or window of claim 102, wherein said device is further comprised of transparent electrical conductors to provide means to apply an activating voltage to said solid state lighting.

104. The glass wall or window of claim 103, wherein said device is further comprised of a microprocessor chip that is programmed to control said solid state lighting and to cause said solid state lighting to display a sequence of images.

105. The glass wall or window of claim 103, wherein there is provided externally to said laminated glass a microprocessor chip that is programmed to control said solid state lighting and to cause said solid state lighting to display a sequence of images.

106. The glass wall or window of claim 104, wherein said microprocessor chip is positioned between said structural laminated glass blocks.

107. The structural laminated glass block of any of claims 73-78, wherein at least one of said n−1 layers of solid non-glass interlayers is illuminated by a light source external to said structural laminated glass block.

108. The structural laminated glass block of claim 79, wherein at least one of said n−1 layers of solid non-glass interlayers is illuminated by a light source external to said structural laminated glass block.

109. A safety illumination system comprising:
(a) a sensor to detect the existence of a safety problem;
(b) an illumination device comprising at least one organic light-emitting diode; and
(c) means to convey a signal from said sensor to said illumination device to impose a voltage across said at least one organic light-emitting diode of said illumination device to activate the said illumination device and thereby provide the desired illumination.

110. The safety illumination system of claim 109, wherein said at least one organic light-emitting diode is a SMOLED.

111. The safety illumination system of claim 109, wherein said at least one organic light-emitting diode is a PLED.

112. The safety illumination system of claim 109, wherein said means to convey a signal from said sensor to said illumination device is electrical.

113. The safety illumination system of claim 1 12, wherein said electrical means to convey a signal from said sensor to said illumination device is wireless.

114. The safety illumination system of claim 109, wherein said sensor, said illumination device and said means to convey a signal from said sensor to said illumination device are integrated into a single device.

115. A smoke detection safety illumination system comprising:
(a) a sensor to detect the presence of smoke;
(b) an illumination device comprising at least one organic light-emitting diode; and
(c) means to convey a signal from said sensor to said illumination device to impose a voltage across said at least one organic light-emitting diode of said illumination device to activate the said illumination device and thereby provide the desired illumination.

116. The smoke detection safety illumination system of claim 115, wherein said said at least one organic light-emitting diode is a SMOLED.

117. The smoke detection safety illumination system of claim 115 wherein said said at least one organic light-emitting diode is a PLED.

118. The smoke detection safety illumination system of claim 115, wherein said means to convey a signal from said sensor to said illumination device is electrical.

119. The smoke detection safety illumination system of claim 118, wherein said electrical means to convey a signal from said sensor to said illumination device is wireless.

120. The smoke detection safety illumination system of claim 115, wherein said sensor, said illumination device and said means to convey a signal from said sensor to said illumination device are integrated into a single device.

121. A gas detection safety illumination system comprising:
(a) a sensor to detect the presence of a gas;
(b) an illumination device comprising at least one organic light-emitting diode; and
(c) means to convey a signal from said sensor to said illumination device to impose a voltage across said at least one organic light-emitting diode of said illumination device to activate the said illumination device and thereby provide the desired illumination.

122. The gas detection safety illumination system of claim 121, wherein said at least one organic light-emitting diode is a SMOLED.

123. The gas detection safety illumination system of claim 121, wherein said at least one organic light-emitting diode is a PLED.

124. The gas detection safety illumination system of claim 121, wherein said means to convey a signal from said sensor to said illumination device is electrical.

125. The gas detection safety illumination system of claim 124, wherein said electrical means to convey a signal from said sensor to said illumination device is wireless.

126. The gas detection safety illumination system of claim 121, wherein said sensor, said illumination device and said means to convey a signal from said sensor to said illumination device are integrated into a single device.

127. A motion detection safety illumination system comprising:
(a) a sensor to detect the presence of motion;
(b) an illumination device comprising at least one organic light-emitting diode; and
(c) means to convey a signal from said sensor to said illumination device to impose a voltage across said at least one organic light-emitting diode of said illumination device to activate the said illumination device and thereby provide the desired illumination.

128. The motion detection safety illumination system of claim 127, wherein said at least one organic light-emitting diode is a SMOLED.

129. The motion detection safety illumination system of claim 127, wherein said at least one organic light-emitting diode is a PLED.

130. The motion detection safety illumination system of claim 127, wherein said means to convey a signal from said sensor to said illumination device is electrical.

131. The motion detection safety illumination system of claim 130, wherein said electrical means to convey a signal from said sensor to said illumination device is wireless.

132. The motion detection safety illumination system of claim 127, wherein said sensor, said illumination device and said means to convey a signal from said sensor to said illumination device are integrated into a single device.

133. A power outage detection safety illumination system comprising:
(a) a sensor comprising a light-sensing device;
(b) an illumination device comprising at least one organic light-emitting diode; and
(c) means to convey a signal from said sensor to said illumination device to impose a voltage across said at least one organic light-emitting diode of said illumination device to activate the said illumination device and thereby provide the desired illumination.

134. The power outage detection safety illumination system of claim 133, wherein said at least one organic light-emitting diode is a SMOLED.

135. The power outage detection safety illumination system of claim 133, wherein said at least one organic light-emitting diode is a PLED.

136. The power outage detection safety illumination system of claim 133, wherein said means to convey a signal from said sensor to said illumination device is electrical.

137. The power outage detection safety illumination system of claim 136, wherein said electrical means to convey a signal from said sensor to said illumination device is wireless.

138. The motion detection safety illumination system of claim 133, wherein said sensor, said illumination device and said means to convey a signal from said sensor to said illumination device are integrated into a single device.
